(19) United States
(12) Patent Application Publication
(10) Pub. No.: US 2007/0069537 A1
(43) Pub. Date: Mar. 29, 2007

(54) Method and Apparatus for Lifting Elongate Cargo

(75) Inventor: Michael W. Crabtree, Katy, TX (US)

Correspondence Address: DEMONT & BREYER, LLC, 100 COMMONS WAY, HOLMDEL, NJ, 07733, US

(73) Assignee: CARGOMAX, INC., Katy, TX (US)

(21) Appl. No.: 11/534,849

(22) Filed: Sep. 25, 2006

Related U.S. Application Data
(60) Provisional application No. 60/719,800, filed on Sep. 23, 2005.

(51) Int. Cl. B66C 1/00

(52) U.S. Cl. 294/67.5

(57) ABSTRACT

An apparatus for constraining and lifting rigid elongated material, such as pipe, is disclosed. The apparatus is structured so that it separates or decouples the pipe-constraining function and the lifting function. Consequently, the pipe-constraining apparatus is not classified as a “lifting” device and a relatively lighter-weight construction can be used to meet regulatory requirements.

### STATEMENT OF RELATED CASES

This application claims priority of U.S. provisional patent application 60/719,800 filed on Sep. 23, 2005, which application is incorporated by reference herein in its entirety.

### FIELD OF THE INVENTION

The present invention relates to an apparatus and method for handling drill pipe or other relatively rigid, elongate objects.

### BACKGROUND OF THE INVENTION

The oil and gas industry utilizes different types of pipe to drill the wells, to construct the wells, and to produce hydrocarbons from the wells. “Drill pipe,” for example, is used to turn the bit and drill the wells. The pipe used to construct the wells is known as “casing,” which encases the open hole that has been drilled into the earth. A pipe known as “tubing” is used to conduct hydrocarbons to the surface for further refinement and distribution in the markets for energy. Consequently, there are a broad range of pipe types, diameters, and lengths used in drilling, constructing and producing a well.

These pipes must be transported to the well site for use. One way to do this is with a pipe storage/transportation apparatus. One such apparatus, which is depicted in FIGS. 1A and 1B, includes a plurality of u-shaped frames. Each frame includes two upright members, a horizontal base that connects the two upright members, and packing elements. The packing elements include cycloid openings for receiving pipe of a specific diameter. Each unshaped frame is capable of receiving several packing members, which can be stacked one above the next so that multiple rows of pipe can be constrained.

Once constrained, the pipe and the constraining apparatus are lifted in one of several ways. In one approach, lifting slings are fastened to the uprights of the frame (see FIG. 2A). A second approach is to directly bundle the constrained pipe with the lifting slings, as shown in FIG. 2B. In this approach, lifting slings are placed beneath the pipe, then wrapped one or more times around the pipe and finally attached to a lifting fall (not shown). Bundling results in increasing compression of the pipe within the sling as the weight increases, wherein the friction of the sling against constrained pipe limits movement of the sling toward the center of gravity of the load. A third approach is to use a separate lifting apparatus within which constrained pipes are placed, as depicted in FIG. 2C.

U.S. Pat. No. 6,182,837 to Crabtree discloses a frame for storing, constraining, and transporting elongate, rigid members, such as pipe. In an advance over the prior art, that frame accommodates pipes of any diameter. (See FIG. 3.) To transport the frame and pipe, slings are attached to uprights (see, e.g., FIGS. 4A and 4B).

Although the apparatus described in U.S. Pat. No. 6,182,837 is an improvement over other pipe-transportation apparatuses, neither it nor other prior art adequately address a need to constrain pipe of differing lengths in such a manner as to balance the weight of the constrained pipe when it is lifted and suspended by slings from a crane fall.

In fact, numerous limitations prevail with existing practice. With regard to the pipe frame depicted in FIGS. 1A and 1B and the associated lifting methods depicted in FIGS. 2A through 2C), the following drawbacks that lead to difficulty in balancing the constrained pipe for lift are observed:
The horizontal spacing between the u-shaped frames are indeterminate and manually set before pipe is loaded into the frames. This subjects the loaded frames to a potential offset in the center of gravity during lifting.
In one approach, a separate lifting frame is required (FIG. 2C).
When the pipe and frames are lifted by bundling slings, the horizontal positions of the slings relative to the center of gravity are limited by the friction of the slings on the pipe. That is, the slings tend to slide toward the center.
Lifting the frames by the uprights creates a reactive force since the pipes tend to be cantilevered beyond the outermost u-shaped frames. The frame must be able to withstand this force.

With regard to the pipe frame that is disclosed in U.S. Pat. No. 6,182,837, the following drawbacks that lead to difficulty in balancing the constrained pipe for lift are observed:
Lifting the frames by the uprights create a cantilevered reactive force that the frame must be able to withstand, as noted above.
Since the frame is treated, by the appropriate regulatory body, as a lifting apparatus, it must be able to withstand up to 2.5× the design load capacity. This fact, in conjunction with the cantilevered reactive forces mentioned above, requires heavy construction. This increases the weight and the cost of the frame.
Lifting by uprights generally leads to difficulty in balancing the load.
Frames with a welded base cannot be safely stacked.
Frames with a welded base are inefficient to transport when empty.
The distance between the u-shaped frame elements are limited by the reactive load.

In view of the foregoing, it is clear that an improved method and apparatus for lifting constrained pipe, etc., is desirable.

### SUMMARY

The prevent invention provides a way to lift elongate bodies, such as pipe, without some of the costs and disadvantages of the prior art.

The illustrative embodiment of the present invention is a pipe-constraining and lifting device wherein the pipe-constraining function and the pipe-lifting function are decoupled from one another. Consequently, the pipe-frame is not classified as a “lifting” device. Therefore, a relatively lighter-weight construction can be used to meet regulatory requirements. This approach increases the load capacity of the pipe frame described herein, so that as many pieces of pipe can be lifted in one lift as a crane is capable of lifting. Furthermore, for the improved pipe frames that are disclosed herein, a method other than friction is used to maintain the position of the lifting slings relative to center of gravity of the load.

In some embodiments, the pipe constraining and lifting device is a modification of prior-art pipe frames, such as the pipe frame that is disclosed in U.S. Pat. No. 6,182,837.

The design criteria for the illustrative embodiment includes at least some of the following considerations:
I. The frame utilizes uprights that are designed solely for constraining pipe, not lifting pipe.
II. The u-shaped frame elements utilize packing elements, with variable vertical positioning. The surface profile of the packing elements can be uniform or non-uniform.
III. To improve load balance, the lifting slings' position is maintained as far as practical from the load center of gravity. It is notable the friction cannot be relied upon to accomplish this.
IV. Establish determinate horizontal spacing between u-shaped frames by means of detachable spacers.
V. Reduce reactive forces upon the uprights and locate the vertical center of gravity of the reactive force equally between the horizontal spacers, thereby equalizing the force imparted to the spacers.
VI. Enable the use of pipe of different average length.
VII. Limit the deflection of the horizontal spacers caused by the reactive force (upon lifting).
VIII. Make the apparatus as light weight as practical (for ease of handling).
IX. Adapt the frames for safe stacking and improved pipe weight distribution.

The design solution includes one or more of the following features:
i. Position the slings beneath the pipe for lifting, but bridled, not choking.
ii. Use, as a minimum, two outer u-shaped frames near the ends of the constrained pipe and a centrally-located u-shaped frame. This limits the length of the horizontal spacers, thereby limiting their deflecting due to reactive force during lift.
iii. Secure the bridling slings to the inside of the outer sets of u-shaped frames by means, for example, of padeyes that are welded to the uprights. The padeyes are advantageously vertically centered between horizontal spacers.
iv. To accommodate pipe of different average lengths, provide interchangeable horizontal spacers of appropriate lengths.

### BRIEF DESCRIPTION OF THE DRAWINGS

FIG. 1A depicts an end view of a prior-art pipe frame for securing and transporting drill pipe, etc. The frame includes upright members, a horizontal base that connects the two upright members, and packing elements, wherein the packing elements include cycloid openings for receiving pipe. Typically, multiple instances of the u-shaped pipe frame (see FIG. 1B) are used to restrain pipe.

FIG. 1B depicts, via side view, four of the prior-art pipe frames of FIG. 1A restraining pipe.

FIG. 2A depicts a first prior-art lifting method for lifting pipe that is secured, for example, by the prior-art pipe frame of FIG. 1A. In this first method, slings are attached to the upright members of the pipe frame.

FIG. 2B depicts a second prior-art lifting method for lifting pipe that is secured, for example, by the prior-art pipe frame of FIG. 1A. In this second method, slings are wrapped around the pipe.

FIG. 2C depicts a third prior-art lifting method wherein the pipe frame is placed in a separate lifting frame to which slings are attached.

FIG. 3 depicts the prior-art pipe frame disclosed in U.S. Pat. No. 6,182,837.

FIGS. 4A and 4B depict a prior-art manner in which the pipe frame of FIG. 3 is lifted.

FIG. 5 depicts a load, in phantom, and depicts a center-of-gravity of the load.

FIG. 6 depicts yokes that are welded to uprights of a pipe frame, such as the pipe frame disclosed in U.S. Pat. No. 6,182,837, to accept horizontal spacers for use with a pipe-constraining and lifting device in accordance with an embodiment of the present invention.

FIG. 7 depicts a detachable link that is attached to the yokes of FIG. 6.

FIG. 8 depicts, via a side view, a bridling sling secured to (one upright of) a frame of a pipe-constraining and lifting device in accordance with the illustrative embodiment of the present invention.

FIG. 9 depicts, via an end view, a modification (relative to the frame disclosed in U.S. Pat. No. 6,182,837) to the uprights of a pipe-constraining and lifting device in accordance with the illustrative embodiment of the present invention. This modification facilitates stacking pipe frames on top of one another.

FIG. 10 depicts, via a side view, spacers attached to successive uprights.

FIG. 11 depicts, via a side view, stacked pipe frames.

FIG. 12 depicts, via a side view, pipe frames and pipe being lifted in accordance with the illustrative embodiment of the present invention.

FIG. 13 depicts, via a side view, a simplified version of FIG. 12 for illustrating why a horizontal compressive force is imparted to the spacers during lifting.

FIG. 14 depicts, via a side view, an optional overhead lifting beam of a pipe-constraining and lifting device in accordance with the illustrative embodiment of the present invention. The lifting beam reduces the horizontal compressive force that would otherwise be generated (e.g., such as via the arrangement of FIG. 13).

FIG. 15 depicts, via a top view, further detail of a spacer for use between successive pipe frames in a pipe-constraining a lifting device in accordance with the illustrative embodiment of the present invention.

FIG. 16 depicts the direction of forces that are imparted by the bridling sling as the pipe frame and constrained pipe are lifted.

FIG. 17 depicts a lower lifting beam for use in conjunction with some embodiments of the present invention.

FIG. 18 depicts the lifting beam of FIG. 17 in use in conjunction with a pipe-constraining and lifting device in accordance with the illustrative embodiment of the present invention.

FIG. 19 depicts, via a side view, a spreader bar for use in conjunction with some embodiments of the present invention.

FIG. 20 depicts, via a top view, the spreader bar of FIG. 19.

FIG. 21 depicts an end view of a pipe-constraining and lifting device in accordance with the illustrative embodiment, wherein a frame contains two rows of pipe, and wherein the spreader bar of FIG. 19 and the lifting beam of FIG. 17 are in use.

FIG. 22 depicts a side view of FIG. 21.

FIG. 23 depicts an embodiment wherein a variable position strap winch is used for rapid re-balancing during lift.

FIG. 24 provides further detail of the winch of FIG. 23 and other re-balancing elements.

FIG. 25 illustrates a load and its center of gravity.

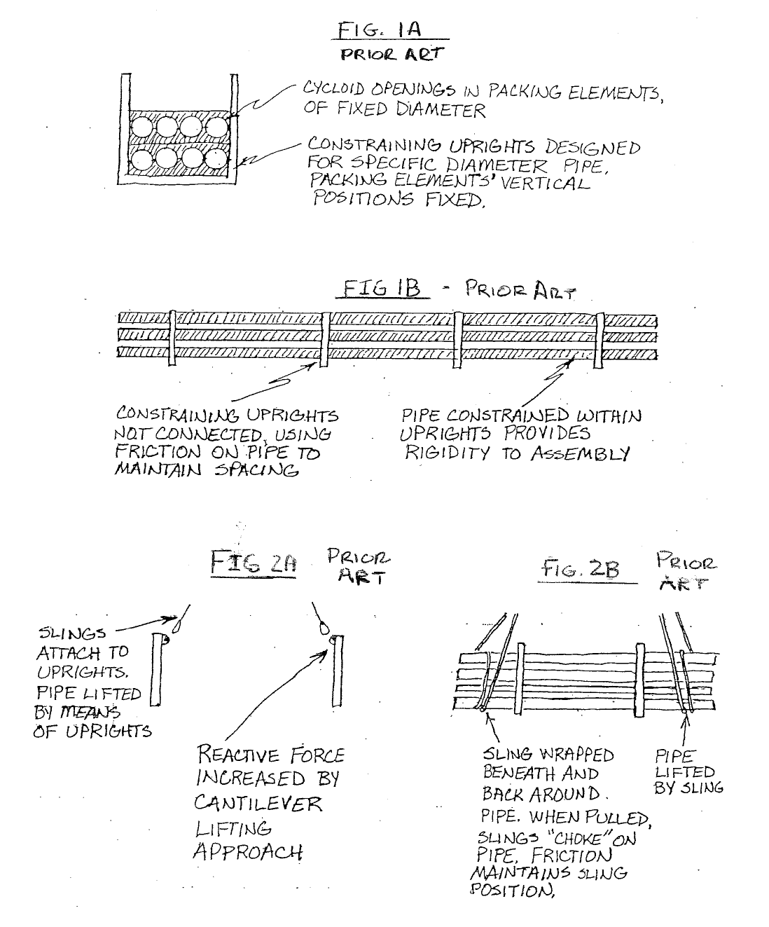

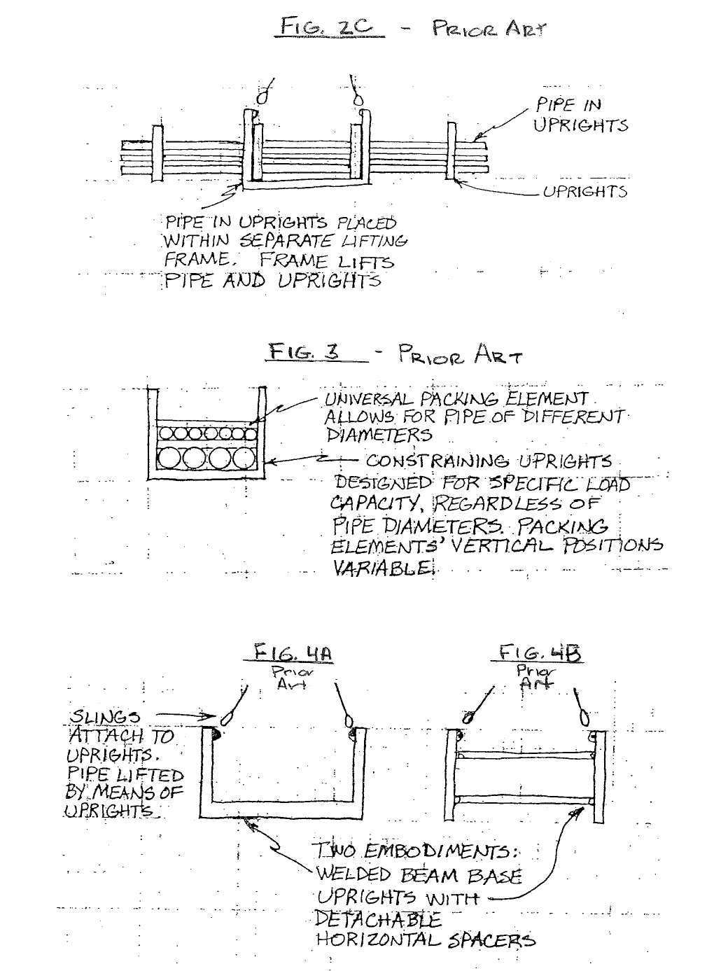

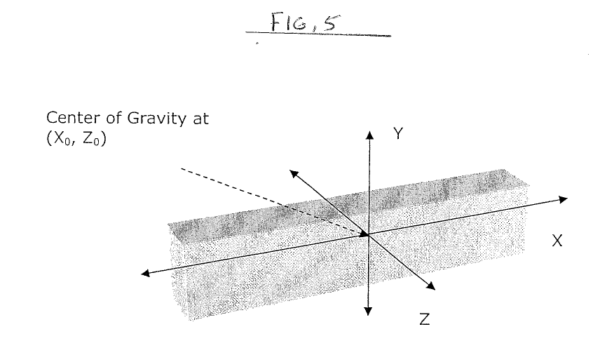

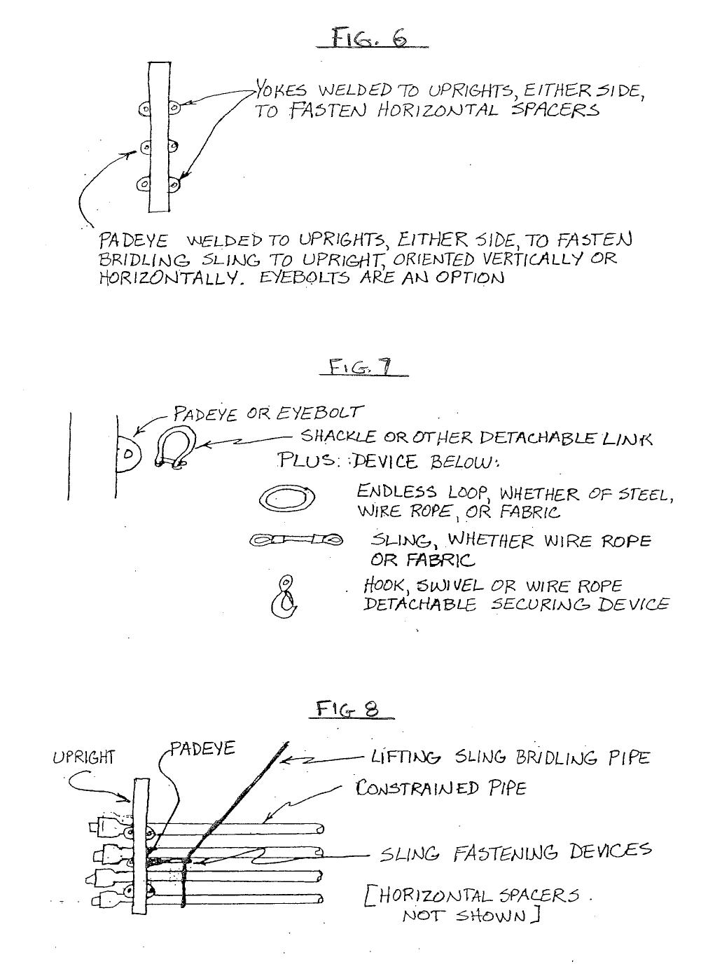

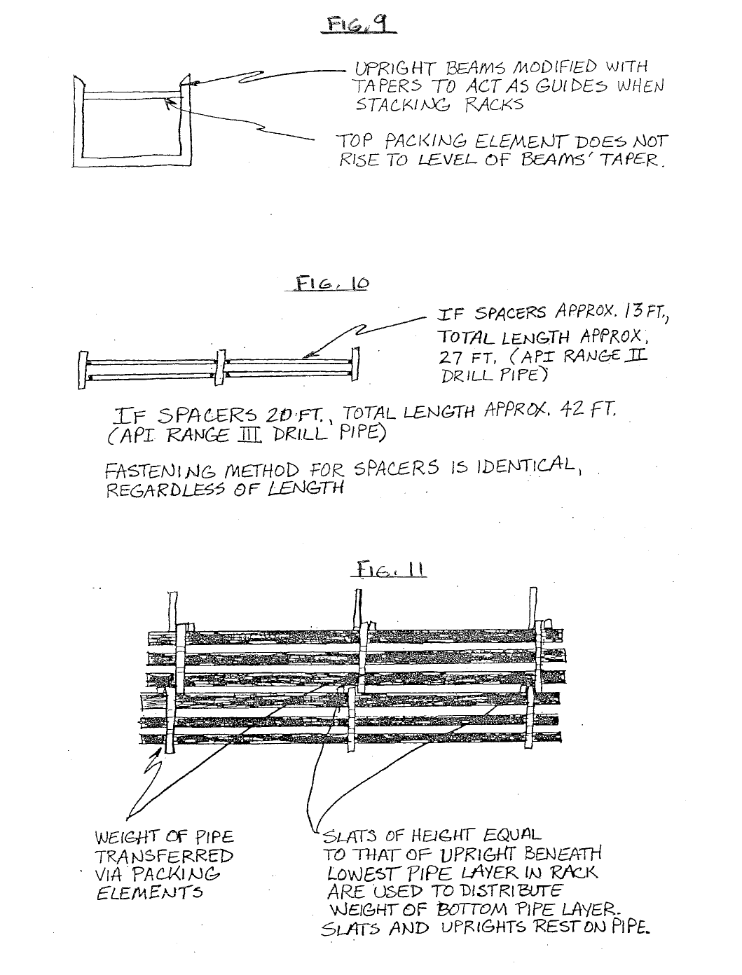

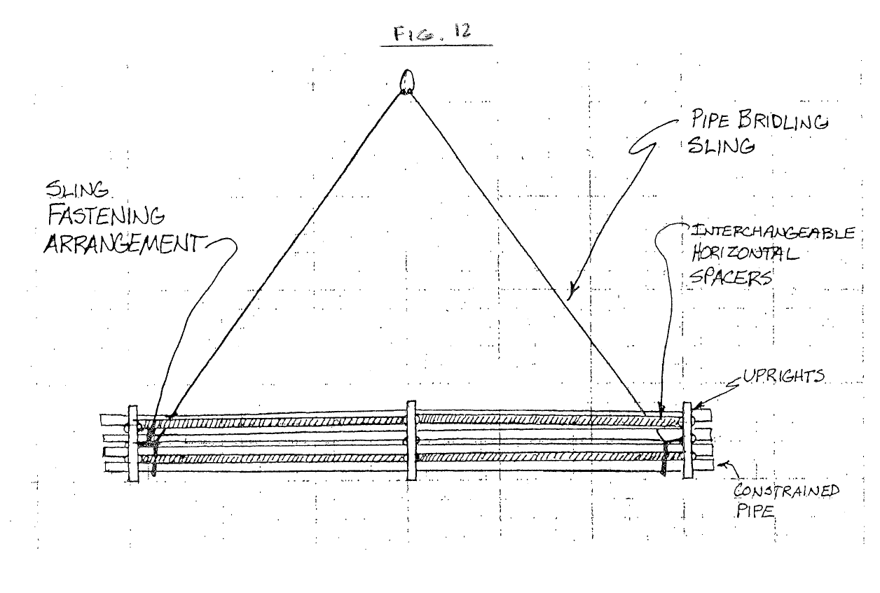

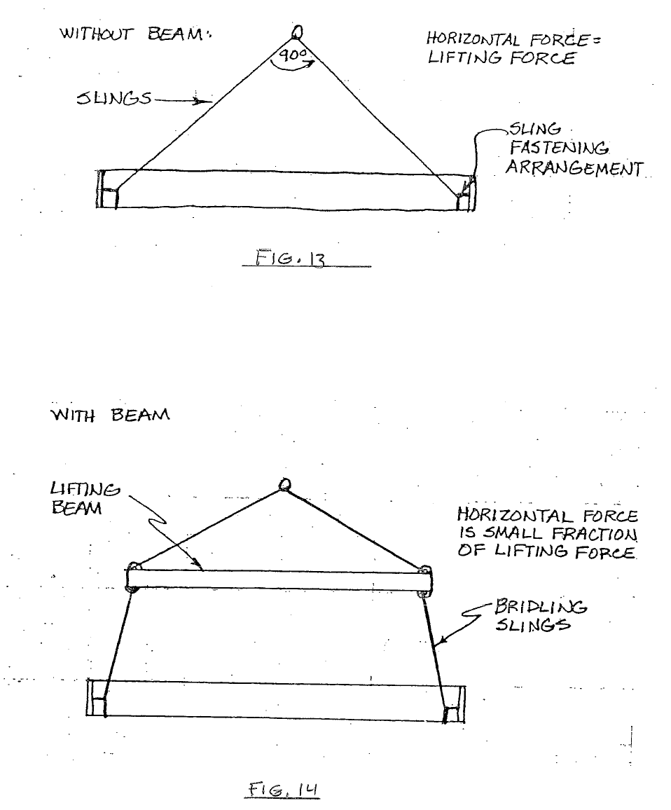

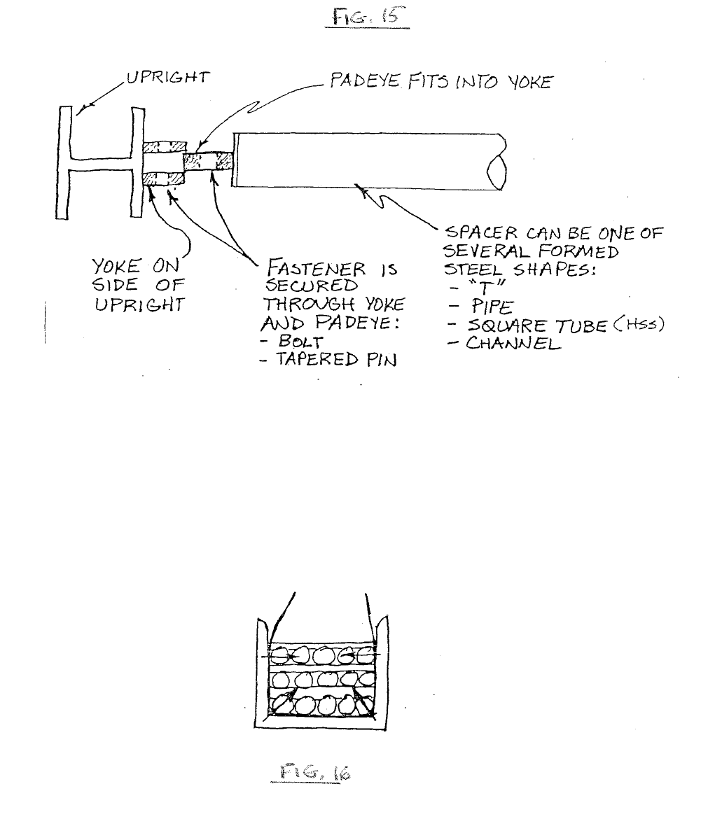

### DETAILED DESCRIPTION

U.S. Pat. No. 6,182,837 is incorporated by reference herein.

In the illustrative embodiment, the pipe frame that is disclosed in U.S. Pat. No. 6,182,837 is modified to provide a pipe-constraining and lifting device. In some other embodiments, other structural arrangements for constraining elongated members can be modified, as described herein, to provide the present pipe-constraining and lifting device.

In accordance with the illustrative embodiment, a pipe-constraining and lifting device includes at least two u-shaped pipe frames, which comprise two spaced, vertically-oriented side members that depend from a base. The (at least) two u-shaped frames, which are spaced apart at some distance from each other, are coupled by detachable horizontal spacers (see, e.g., FIGS. 10 and 15). Often, three or four of such pipe frames are used to provide a single pipe-constraining and lifting device.

The u-shaped frames constrain cargo pipe by means of “cross members” or “packing elements,” which are disposed between the vertically-oriented side members. (See, e.g., FIG. 3.) The packing elements are coupled to the side members in such a way that the packing elements are freely movable in the vertical direction, sliding up or down between the vertical side members.

Pipe is laid on a bottom-most packing element, and then another packing element is disposed on that layer of pipe. This arrangement is repeated wherein two packing elements, one below and one above, sandwich a layer of pipe. An upper-most packing element, which rests on an upper-most layer of pipe, is compressed (e.g., by a chain and tensioning member, etc.). Friction of the packing elements and position of uprights thereby constrain pipe movement in three dimensions, within the u-shaped frames. The packing elements are elastomer coated, and can have surface profiles that are uniform or non-uniform. In U.S. Pat. No. 6,182,837, non-uniform profiles are specified; however, in some other embodiments, uniform profiles are used.

The foregoing arrangement is not new; it has been disclosed in U.S. Pat. No. 6,182,837. The following disclosure details how that arrangement is improved by virtue of the present invention.

The outer most u-shaped frames define a quadrangle in which the center of gravity of the cargo resides. During lifts, forces are imparted to the cargo in the X, Y and Z planes. Load imbalances occur when the vertical lifting force (in the Y plane) is imparted at points that are not equidistant from the center of gravity of the load.

Referring to FIG. 5, if the center of gravity is at the point (X₀, Z₀), and four lifting points (not shown) are at fixed distances in the horizontal (X) and lateral (Z) planes from (X₀, Z₀), then the Y force magnitude is centered at a point equidistant from these lifting points, and the load is balanced. A balanced load can therefore be considered one in which the Y component has no magnitude in the X and Z planes other than at (X₀, Z₀).

The problem arises when the center of gravity is not at (X₀, Z₀), but at some other location (Xₐ, Zₐ). In this case, the magnitude, F, of the Yₐ component is given by:
F=Cₘ(Xₐ²+Zₐ²)^{0.5}
where Cₘ is the mass of the cargo.

In the prior art, wherein the cargo is lifted from points that are at fixed and equidistant locations from (X₀, Z₀), an offset in the center of gravity is compensated for by shortening the lifting-leg lengths, usually by chain falls that are attached to slings between the cargo and the crane fall. In this manner, the shortened lifting legs result in shifting the center of gravity the distance of the Xₐ and Zₐ components.

In accordance with the illustrative embodiment, this situation is avoided by eliminating fixed lifting points. Rather, independent variability is allowed in the four lifting points in the X and Z planes.

To accommodate pipe of different lengths, the independent u-shaped frames are separated by horizontal spacers (see, e.g., FIG. 10) of different lengths. A center u-shaped frame is utilized to add rigidity to the assembly, thereby limiting the deflection of the spacers owing to overall length. The spacers establish a determinate distance between the u-shaped frames, thereby eliminating the problems of initial spacing of the u-shaped frames that are associated with the independent u-shaped frames in the prior art.

In the prior art, all slings that bridle the constrained pipe bundle the pipe and use friction to maintain the position of the sling relative to the center of gravity of the load. Bridling slings can support the entire load, but a method other than friction must be employed to maintain sling position relative to the outer u-shaped frames.

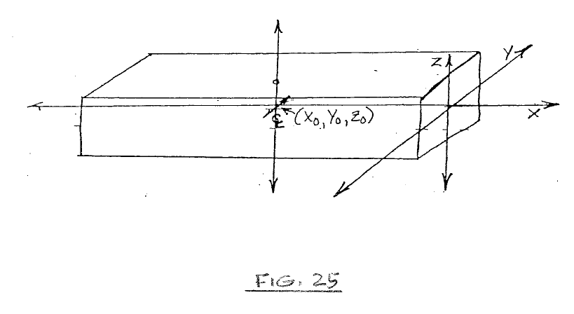

In accordance with the illustrative embodiment, variability is permitted in the lifting points by fastening the bridling slings to the interior of the outer u-shaped frames, by means of a fastening device. In various embodiments, the fastening device is a wire-rope winch, webbing-sling winch, or a ratchet, which is attached to the interior of each outside u-shaped frame. (See, e.g., FIGS. 7 and 8.) The wire rope or webbing sling length is adjustable, by means of the four winches attached to the interior of the outside u-shaped frames that define the quadrangle within which center of gravity of the load resides. (See, e.g., FIGS. 23 and 24.) In this manner, the four points at which the lifting slings impart vertical forces to the cargo within the quadrangle can be independently varied relative to the four quadrangle corners.

The fastening devices impart a proportion of the lifting force to the u-shaped frames in the form of a horizontal compressive force in the direction of the center of gravity (see, e.g., FIG. 16), with an equal division of force among the horizontal spacer pairs on each side of the u-shaped frame. This reduces both the reactive force during lifts and the compressive force imparted to each horizontal spacer. This method equalizes the force between the horizontal spacers in a compressive manner, so that the deflective/bending force imparted to the individual horizontal spacers is kept to a practical minimum.

In some embodiments, the horizontal spacers between u-shaped frames are detachable (see, e.g., FIG. 15). This enables the quadrangular assembly to be broken down into components for transport when not in use. In some embodiments, detachable and physically interchangeable horizontal spacers of varying lengths can be used to make the quadrangle length longer or shorter, as desired. This is beneficial in lifting pipe of different lengths, such as drill pipe and casing. Oil-well drill pipe comes in two length ranges established by the American Petroleum Institute (API), API Range II (approximately 31 feet) and API Range III (approximately 45 feet). Casing pipe varies in length, and is often 50 feet long.

The benefit in changing the length of the quadrangle in which the center of gravity resides is in establishing the quadrangle corners as close as practical to the ends of the constrained pipe. This results in a more precise pipe loading, relative to the center of gravity and the quadrangle length midpoint, than if the length of the quadrangle is significantly less than the length of the constrained pipe. Hence, varying the length of the quadrangle begins the pipe loading process with more precise pipe placement relative to the quadrangle center. The differential between the horizontal center of gravity of the load and the horizontal center point of quadrangle is thereby minimized. This results in a decrease in the distance by which sling position is changed.

In some embodiments, the four points at which the lifting slings will initially impart vertical force to the constrained pipe are established at points that are equidistant from each of the quadrangle corners. This is done by setting the four wire ropes or webbing slings to a uniform length from each corner upright. In this manner, the initial lifting points are equidistant from each quadrangle corner, and the presumption is that the four lifting points are equidistant from the load center of gravity.

If a lift attempt demonstrates that one end of the quadrangle is lifted before the other, the load is not balanced (e.g., the end that lifts first is lighter than the other end). If the quadrangle is lifted in this manner, the horizontal compressive force imparted by the lifting slings is less on the lighter quadrangle end than on the heavier quadrangle end. The position of the bridling sling on the end that is heavier can be drawn closer to the quadrangle corners on the heavier side by shortening the sling fastening device (see, e.g., FIGS. 7 and 8), thereby shortening the distance between the sling position and the quadrangle corner. The process of lifting the quadrangle and adjusting the slings' positions relative to the quadrangle corners can be repeated until the quadrangle ends lift simultaneously, indicating a balanced load.

The cause of the unbalanced loading problem during lift is due to imprecision in the placement of pipe into the u-shaped frames. If the outermost u-shaped frames are spaced apart such that the ends of the constrained pipe are close to those frames, a highly unbalanced load is very unlikely. Note too, that with this arrangement, the differential between the bridling slings' positions and the center of gravity of the load is reduced.

While it is advantageous for the ends of the pipe to be closed to the outermost u-shaped frames as described above, it is not necessary that the bridling slings be in close proximity to those outer frames. An alternative to the arrangement depicted in FIG. 8 (wherein the bridling sling is close to the outer frames) is to simply begin with the bridling slings at an arbitrary but fixed distance from the outer u-shaped frames. An initial attempt to lift the constrained pipe will indicate if there is any load imbalance. A device that couples each bridling sling to an outer frame enables changing the position of the bridling sling relative to that outer frame. The bridling sling on the heavier side (as determined by the trial lift) is simply moved closer to outer frame to which it's coupled, thereby balancing the load.

This can be achieved by replacing the padeyes on the uprights of the u-shaped frames with cargo strap/rope winches, which are welded to the “inner” side of the uprights of the outermost u-shaped frames. (See FIGS. 23 and 24.) In some embodiments, each winch includes a sufficient amount of strap or rope to span the distance initially established between the upright (that it's attached to) and the bridling sling.

With reference to FIG. 25, the reaction of lifted cargo to load imbalances is with regard to the load center of gravity in three planes. Sling placement required to balance a lifted load is subject to correction in two dimensions: X and Y. The magnitude of the Z plane vectors depends upon the relative imbalance in the X and Y planes. It is therefore practical to balance a lifted cargo within a quadrangular confinement by eliminating the component Z by controlling two of the bridling slings' positioning in the X and Y planes. This requires four independently-adjustable lengths established at quadrangle corners within which the load center of gravity occurs. These corrections via sling position need not be exact nor calculated as long as a means exists to establish a fixed lifting position for each leg of the bridling slings relative to the load center of gravity.

A method for establishing relative positions for each sling is to secure each bridling sling to a quadrangle-defining upright, with a tether coupled to the upright and the sling. The tether is variable in length, by means of a ratcheting mechanism or other device that both establishes the tether length (between the quadrangle “post” and the sling) and provides sufficient force resistance to maintain tether length during lifts.

It is notable that when cargo to be lifted can be constrained and the lifting forces accommodated by a quadrangular arrangement defined by fixed uprights (e.g., of the u-shaped frames), the cargo can be lifted by only two bridling slings. The current industry lifting practice is to employ means such as variable-length chain falls on independent slings to execute lifts in which four lifting points (i.e., four slings) must be used.

When the load is balanced, horizontal compressive forces upon the horizontal spacers are nearly equal. Precise loading calculations on the sling legs are not required, as long as the angle-of-incidence of the sling relative to the horizontal plane does not impart more compressive horizontal force than can be accommodated by the quadrangle horizontal spacers, the adjustable wire rope/webbing slings or winches, or the tensile strength of the lifting slings. In this manner, quick and sufficiently accurate adjustments to the sling lifting positions on the constrained pipe can be effected.

One method for minimizing or otherwise reducing the angle of incidence between the vertical and the horizontal plane of the quadrangle is to use a spreader bar attached to the crane fall, with lifting slings attached to the spreader bar. (See, e.g., FIGS. 19-22.) This method is particularly desirable when lifting very long pipe such as casing, as it improves the overall stability of the load during the lift.

The arrangement and methods described herein are such that overall assembly (i.e., the pipe-constraining apparatus comprising at least two u-shaped frames coupled by horizontal spacers) is not designated a transport frame for regulatory purposes. The u-shaped frames merely constrain the pipe, and horizontal forces that imparted from lifting bridling slings are compensated for by compression of the horizontal spacers. No vertical forces are imparted to the u-shaped frames other than by the constrained pipe. As a consequence, the u-shaped frames are not, therefore, a part of a lifting apparatus. Instead, the slings lift the pipe, and the u-shaped frames and horizontal spacers merely absorb the horizontal forces imparted during lifts. The u-shaped frames otherwise sustain relative positions of pipe constrained within and the relative horizontal positions of the other u-shaped frames. This permits the u-shaped frames to be constructed from lightweight materials.

A separate consideration is the forces that are imparted to constrained pipe by the bridling slings during lifts. These forces might damage pipe that has thin walls. Consequently, a means to eliminate these forces is desirable or perhaps necessary.

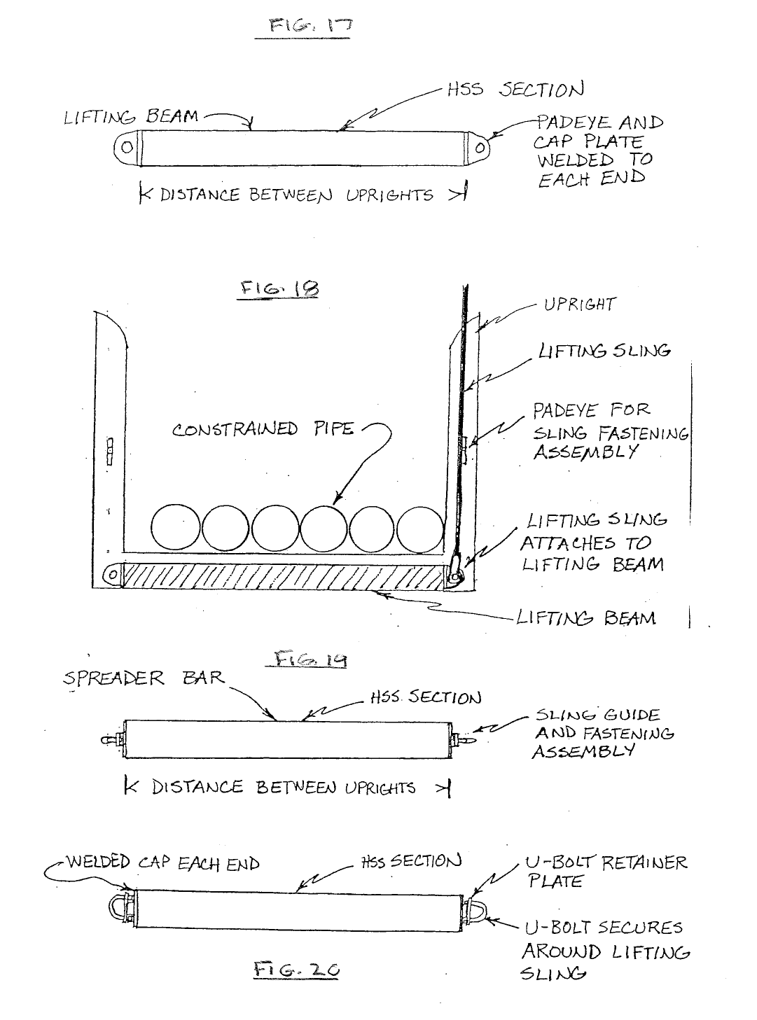

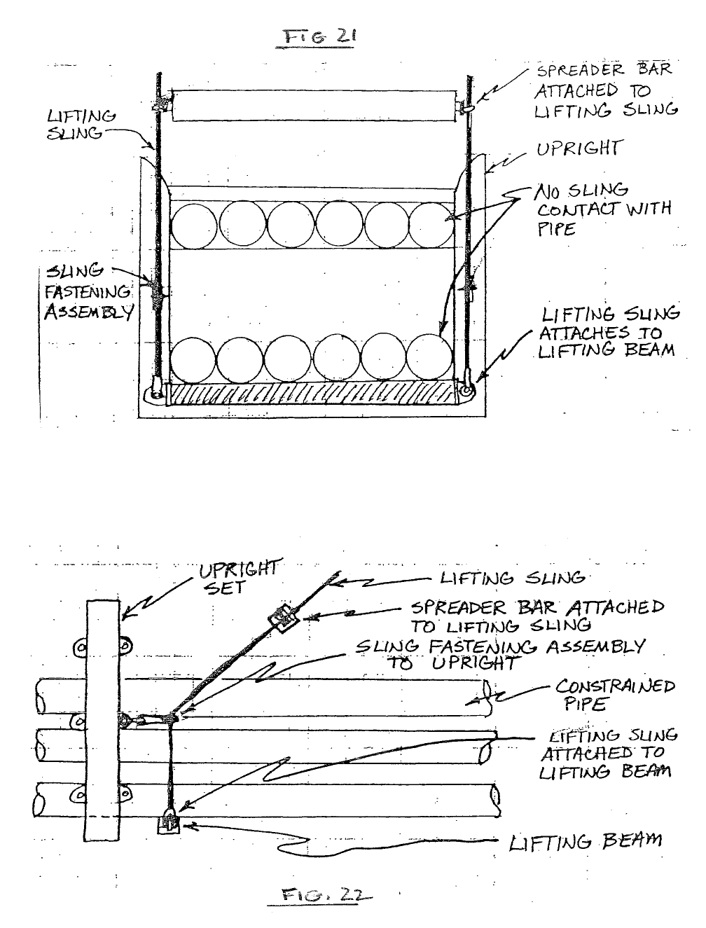

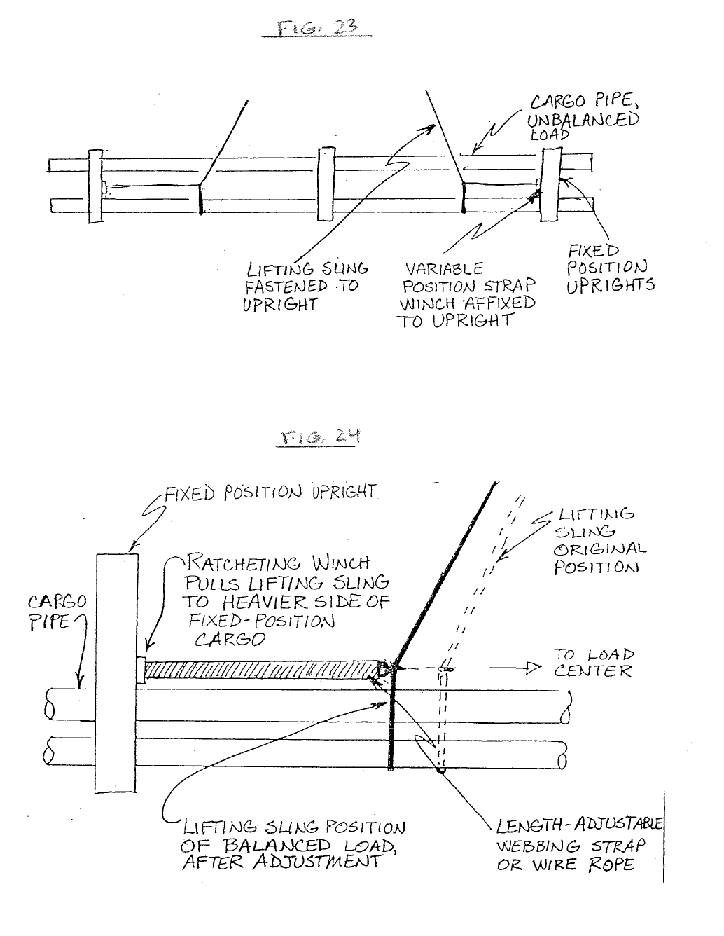

One solution is a combination of using lifting beams (see, e.g., FIGS. 17 and 18) beneath the constrained pipe and spreader bars (see, e.g., FIGS. 19 and 20) above the pipe. The lifting slings fasten to the lifting beams and the spreader bars are secured to the lifting slings above the pipe (see, e.g., FIGS. 21 and 22).

Numerous devices and methods can be used to compress the uppermost packing element, as was stated in U.S. Pat. No. 6,182,837. One method is to utilize ratcheting binding straps secured to the interior base of the u-shaped frames. Joined over the top packing element, these enable a uniform force to be exerted upon the uppermost packing element or directly upon the pipe in the event that a top packing element is not utilized. A similar approach can be taken using chains secured to the interior bases of the u-shaped frames.

One potential practical limitation exists regarding elastomer selection (for the cross member). No limit has been established regarding the quantity of pipe-constraining apparatuses that can be stacked one upon another. There might be a practical limitation owing to the deformation of the elastomer under compression and the shear stresses versus bond strength of the elastomer on the packing element metallic core. This is an operational consideration that might result in operational limitations.

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other methods, materials, components, etc.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents

What is claimed:

1. An apparatus comprising:
a first u-shaped upright pair and a second u-shaped upright pair for constraining movement of rigid cargo, wherein said upright pairs are spaced apart from each other thereby defining a quadrangle, and wherein a center of mass of said cargo falls within said quadrangle;
a plurality of spacers that couple to said upright pairs and that space said upright pairs apart from each other;
a plurality of tethers, wherein:
said tethers fasten, near a first end thereof, to said two u-shaped pairs such that each corner of said quadrangle, as defined by said u-shaped pairs, is fastened to at least one of said tethers;
said tethers fasten, near a second end thereof, to a sling; and
said tethers are independently variable in length between said first end
and said second end thereof; and wherein said sling imparts a vertical lifting force to one of (1) said cargo and (2) beams that are disposed beneath said cargo, but not to said upright pairs or to said tethers.

2. The apparatus of claim 1 wherein two of said spacers separate said upright pairs from one another, and wherein said spacers are detachably coupled to said upright pairs.

3. The apparatus of claim 1 wherein a third upright pair is placed between said first and second u-shaped upright pair.

4. The apparatus of claim 1 wherein said tethers are fastened to the lifting slings by fastening devices, and wherein said lifting slings slide within said fastening devices, thereby enabling said slings to reach an equal length on either side of the cargo when said cargo is lifted.

5. The apparatus of claim 1 wherein points at which said tethers fasten to said upright pairs are equidistant between said spacers.

6. The apparatus of claim 1 further comprising a winching device, wherein said winching device adjusts said length of said tethers.

7. The apparatus of claim 6 wherein said winching device is coupled to a side of said u-shaped uprights, wherein said side faces said center of mass of said cargo.

8. The apparatus of claim 7 wherein said winching device is selected from the group consisting of mechanically ratcheting winching devices, manually manipulated winching devices, and power-driven winching devices.

9. The apparatus of claim 1 wherein said tethers are detachable from said u-shaped upright pairs.

10. The apparatus of claim 1 wherein said tether comprises a length-adjustment mechanism.

11. The apparatus of claim 4 further comprising a spreader beam, which is fastened to said sling.

12. A method for lifting constrained cargo, the method comprising:
coupling tethers to four corners of quadrangle, wherein said quadrangle is defined by upright members that used for constraining said cargo;
independently altering a length of said tethers thereby independently varying horizontal locations at which vertical lifting force is imparted to said cargo.

13. The method of claim 12 wherein a length of said tethers is initially equal.

14. The method of claim 13 wherein said length of at least one of said tethers is adjusted to balance said cargo.
